(19) United States
(12) Patent Application Publication
(10) Pub. No.: US 2024/0375256 A1
(43) Pub. Date: Nov. 14, 2024

(54) Split Ring Pliers

(71) Applicant: Toit Fishing Limited, Hartford (GB)

(72) Inventor: Warren Shawn du Toit, Hartford (GB)

(21) Appl. No.: 18/691,973

(22) PCT Filed: Aug. 31, 2022
(86) PCT No.: PCT/GB2022/052222

§ 371 Date: Mar. 14, 2024

(30) Foreign Application Priority Data
Sep. 22, 2021 (GB) 2113512.4

(51) Int. Cl. B25B 27/20

(52) U.S. Cl. CPC B25B 27/205

(57) ABSTRACT

Apparatus (10) for opening a split ring comprises a pair of levers (12, 14) which are pivotally coupled together and define a first jaw (20) and an opposing second jaw (22). A member (30) is mounted on the first jaw (20). The member (30) has a wedge-shaped profile, tapering from a base region (32) adjacent the first jaw (20) to a tip region (34) spaced from the base region (32). The tip region (34) is configured for insertion between adjacent helical turns of a split ring when gripped between the first and second jaws (20, 22). The tip region (34) has an arcuate peripheral edge (36) that extends at least partially around a longitudinal axis (38) of the first jaw (20).

### TECHNICAL FIELD

The present invention relates to apparatus for opening a split ring.

### TECHNICAL BACKGROUND

A split ring is a well-known form of coupling (e.g. to join a lure to a fishing hook) and typically comprises two substantially helical turns of a metal wire which are biased tightly together. An object may be strung onto the split ring by forcing apart the helical turns to expose one end of the metal wire. Various kinds of hand tools may be used to “open” a split ring, i.e. force the helical turns apart, but sometimes specialist tools known as split ring pliers are used (for example, see US 2017/0332743, EP 3106264, U.S. Pat. No. 5,839,141 and JP3215762). One form of split ring pliers has a pair of opposed jaws, with one jaw defining a notch for supporting a radially inner periphery of the split ring and the other jaw having a protruding tip for insertion between adjacent helical turns when urged towards the opposing jaw. However, considerable force may sometimes be required to overcome the force biasing the helical turns together, particularly in larger split rings. It may also be difficult to control the separation between the helical turns without damaging the split ring, especially the surface thereof which may be coated to enhance corrosion resistance. In some cases, even once the helical turns have been separated, additional adjustment may still be required in extreme cases to fit very large objects (e.g. hooks or wires) onto a split ring, necessitating use of different sizes of split ring tools. The present invention seeks to address such issues.

### SUMMARY OF THE INVENTION

In accordance with a first aspect of the present invention, there is provided apparatus for opening a split ring, comprising: a pair of levers pivotally coupled together to define opposed first and second jaws and corresponding handles for opening and closing the first and second jaws; and a member mounted on the first jaw, the member having a wedge-shaped profile, tapering from a base region adjacent the first jaw to a tip region spaced from the base region, with the tip region being configured for insertion between adjacent helical turns of a split ring when gripped between the first and second jaws, wherein the tip region has an arcuate peripheral edge which extends from at least one lateral side of the first jaw to the other, wherein the arcuate peripheral edge of the tip region extends at least partially around a longitudinal axis extending along one lever from the first jaw towards the corresponding handle.

Advantageously, the arcuate peripheral edge is relatively easy to align with a split ring prior to insertion of the tip region between adjacent helical turns of the split.

The first jaw may be elongate. The arcuate peripheral edge of the tip region may extend at least 180° around the longitudinal axis, perhaps even at least 240° around the longitudinal axis. In one arrangement, the arcuate peripheral edge of the tip region extends fully around the first jaw, i.e. 360° around the longitudinal axis.

The member may have a first surface extending from the tip region to the base region which faces towards a pivot axis of the pair of levers. The first surface may be curved around the longitudinal axis of the first jaw, for example curving in sympathy with the arcuate peripheral edge of the tip region. The first surface may at least in part be substantially frustoconical, i.e. a notional line from the tip region to the base region is linear. Alternatively, the first surface may also be concave or convex, i.e. a notional line from the tip region to the base region may be non-linear. In other words, the first surface may curved in two orthogonal planes, one perpendicular to the longitudinal axis and one parallel to the longitudinal axis.

The member may also have a second surface extending from the tip region to the base region which faces away from the pivot axis of the pair of levers. The second surface may also be curved around the longitudinal axis of the first jaw, for example curving in sympathy with the arcuate peripheral edge of the tip region. The second surface may at least in part be substantially frustoconical, i.e. a notional line from the tip region to the base region is linear. Alternatively, the second surface may also be concave or convex, i.e. a notional line from the tip region to the base region may be non-linear. In other words, the second surface may curved in two orthogonal planes, one perpendicular to the longitudinal axis and one parallel to the longitudinal axis.

The first and second surfaces may be symmetrical on opposite sides of the arcuate peripheral edge of the tip region. Alternatively, the first and second surfaces may be asymmetrical on opposite sides of the arcuate peripheral edge of the tip region.

The curvature of the first and second surfaces advantageously provides a 3D wedge effect which allows greater control of split ring opening even after maximum insertion of the tip region between adjacent helical turns. Once the tip region has been fully inserted between adjacent helical turns, split ring opening may be further increased by subsequently rotating the pair of levers relative to the split ring. In doing so, the helical turns will be supported by portions of the first and second surfaces which are not only spaced axially along the longitudinal axis of the first jaw but also circumferentially spaced around the arcuate peripheral edge of the tip region. Furthermore, the portions of the first and second surfaces supporting the helical turns in this configuration will be substantially tangential to the helical turns. In this way, the helical turns supported in a stable manner, whilst minimising the risk of scratching the surfaces of the split ring.

A portion of the first jaw adjacent the member may have a rounded cross section, and may for example be cylindrical or frustoconical. The portion of the first jaw may be between the member and pivot axis of the pair of levers.

The second jaw may be elongate and may have a respective longitudinal axis. The second jaw may have a rounded cross section, and may be cylindrical or frustoconical.

At least one jaw may comprise a distal part releasably coupled to a proximal part, with the distal and proximal parts extending along the longitudinal axis. One part may comprise a socket, and the other part may comprise a shaft which is received in the socket. The socket and the shaft may comprise inter-engaging screw threads for releasably coupling the distal part to the proximal part. The at least one jaw may be the first jaw, and the distal part may comprise the member having the wedge-shaped profile. In this way, the distal part may be released from the proximal part and replaced with another distal part. For example, a plurality of distal parts may be provided, each with a respective member of a different size to the others, for use with split rings of different sizes.

### BRIEF DESCRIPTION OF THE DRAWINGS

An embodiment of the invention will now be described by way of example and with reference to the accompanying figures, in which:

FIG. 1 is a schematic illustration of apparatus for opening a split ring, according to one embodiment of the present invention;

FIG. 2 is a sectional illustration showing jaw detail of the apparatus of FIG. 1;

FIGS. 3A, 3B and 3C show respectively top, side and sectional detail of a first stage of opening a split ring with the apparatus of FIG. 1 (with FIG. 3C being a section along line AA in FIG. 3A);

FIGS. 4A, 4B and 4C show respectively top, side and sectional detail of a second stage of opening a split ring with the apparatus of FIG. 1 (with FIG. 4C being a section along line BB in FIG. 4A), subsequent to the first stage of FIGS. 3A, 3B and 3C;

FIGS. 5A, 5B and 5C show respectively top, side and sectional detail of a third stage of opening a split ring with the apparatus of FIG. 1 (with FIG. 5C being a section along line CC in FIG. 5A), subsequent to the second stage of FIGS. 4A, 4B and 4C;

FIGS. 6A-6F illustrate different jaw details, any of which may be used in the apparatus of FIG. 1; and

FIG. 7 shows sectional detail of apparatus for opening a split ring, according to another embodiment of the present invention.

### DESCRIPTION OF SPECIFIC EMBODIMENT

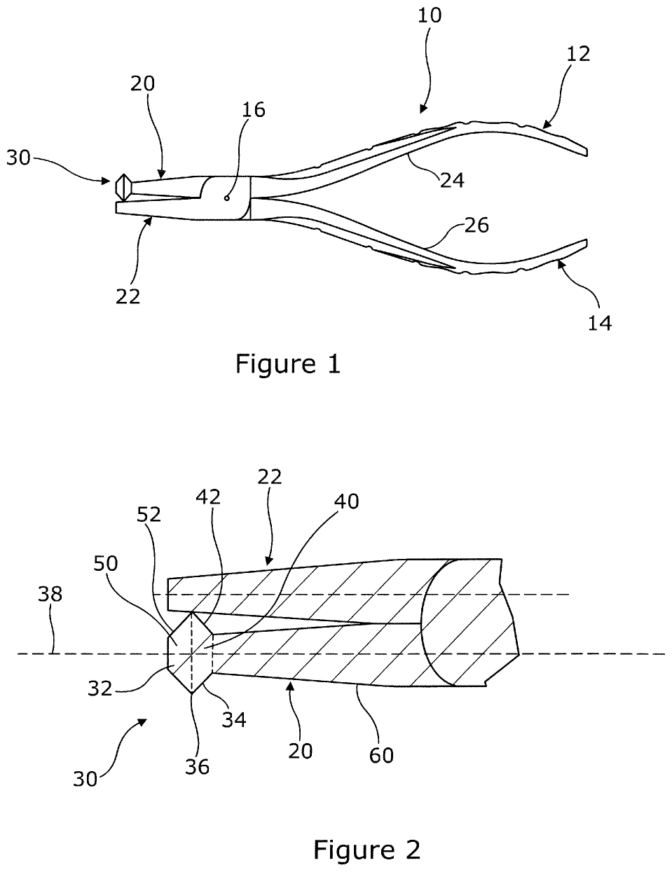

FIGS. 1 and 2 illustrate schematically apparatus 10 for opening a split ring, in accordance with an embodiment of the present invention. The apparatus 10 comprises a pair of levers 12, 14 which are pivotally coupled together at pivot point/axis 16. The pair of levers 12, 14 define on one side of the pivot point/axis 16 a first jaw 20 and an opposing second jaw 22. The pair of levers 12, 14 also define on the other side of the pivot point/axis 16 corresponding handles 24, 26 for opening and closing the first and second jaws 20, 22. The apparatus 10, also comprises a member 30 mounted on the first jaw 20. The member 30 has a wedge-shaped profile, tapering from a base region 32 adjacent the first jaw 20 to a tip region 34 spaced from the base region 32. The tip region 34 is configured for insertion between adjacent helical turns of a split ring when gripped between the first and second jaws 20, 22, as explained in more detail below. The tip region 34 has an arcuate peripheral edge 36 that extends at least partially around a longitudinal axis 38 of the first jaw 20, with the longitudinal axis 38 extending along lever 12 from the first jaw 20 towards the corresponding handle 24.

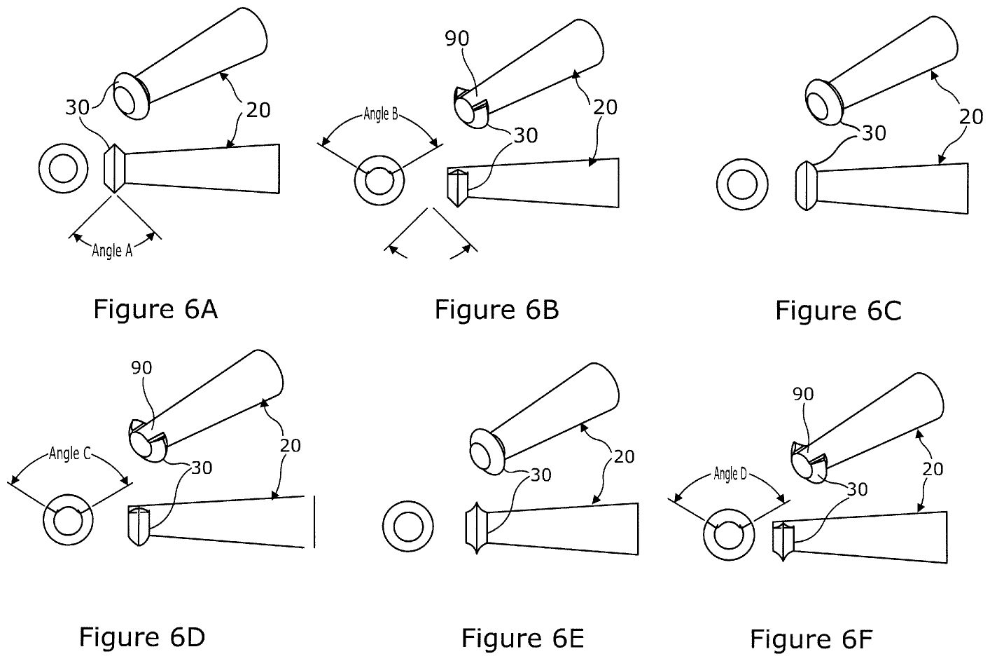

In the arrangement of FIGS. 1 and 2, the member 30 comprises two frustoconical sections 40, 50, arranged back to back to form the arcuate peripheral edge 36 of the tip region 34. In this way, the arcuate peripheral edge 36 is circular, extending fully around the longitudinal axis 38 of the first jaw 20 (see also FIG. 6A). The frustoconical section 40 has a surface 42 extending from the tip region 34 to the base region 32 which faces towards the pivot point/axis 16 of the pair of levers 12, 14. The surface 42 is curved around the longitudinal axis 38 of the first jaw 20, curving in sympathy with the arcuate peripheral edge 36 of the tip region 34. The frustoconical section 50 has a surface 52 extending from the tip region 34 to the base region 32 which faces away from the pivot point/axis 16 of the pair of levers 12, 14. The surface 52 is curved around the longitudinal axis 38 of the first jaw 20, curving in sympathy with the arcuate peripheral edge 36 of the tip region 34.

The member 30 is mounted at one end of the first jaw 20, and is spaced from the pivot point/axis 16 by an elongate portion 60 of the first jaw which has a round cross section. The second jaw 22 is elongate and also has a round cross section.

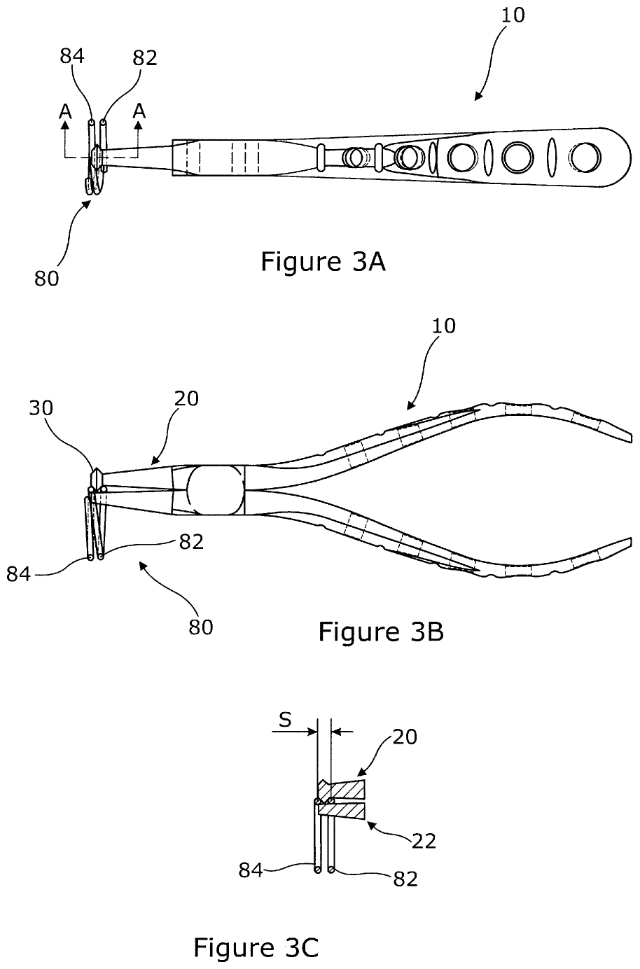

FIGS. 3A, 3B and 3C illustrate schematically a first stage of opening a split ring 80 with the apparatus 10. The split ring 80 has two substantially helical turns 82, 84 which are resiliently biased together. A section of the split ring 80 is gripped between the first and second jaws 20, 22 with the arcuate peripheral edge 36 of the tip region 34 aligned with a boundary between the helical turns 82, 84. As the first and second jaws 20, 22 engage the split ring 80, the surface 42 pushes one helical turn 82 towards the pivot point/axis 16 and the surface 52 pushed the other helical turn 84 away from the pivot point/axis 16, causing the helical turns 82, 84 to separate by an amount “S”.

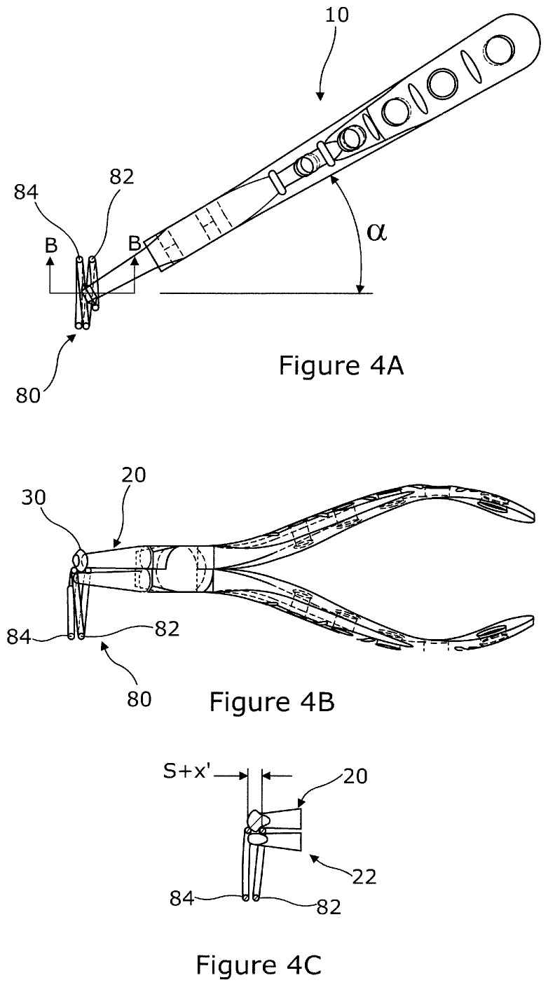

FIGS. 4A, 4B and 4C illustrate schematically a second stage of opening the split ring 80 with the apparatus 10, subsequent to the first stage. As shown by comparing FIGS. 3A and 4A, the apparatus 10 is rotated through an angle “α” relative to the split ring 80. This has the effect of twisting the member 30 between the helical turns 82, 84. In doing so, the helical turns 82, 84 will be supported by portions of the surfaces 42, 52 which are not only spaced axially along the longitudinal axis 38 of the first jaw 20, but also circumferentially spaced around the arcuate peripheral edge 36 of the tip region 34. This causes the helical turns 82, 84 to be separated further to an amount “S+x¹”. Furthermore, the portions of the surfaces 42, 52 engaging the helical turns 80, 84 in this configuration will be substantially tangential thereto.

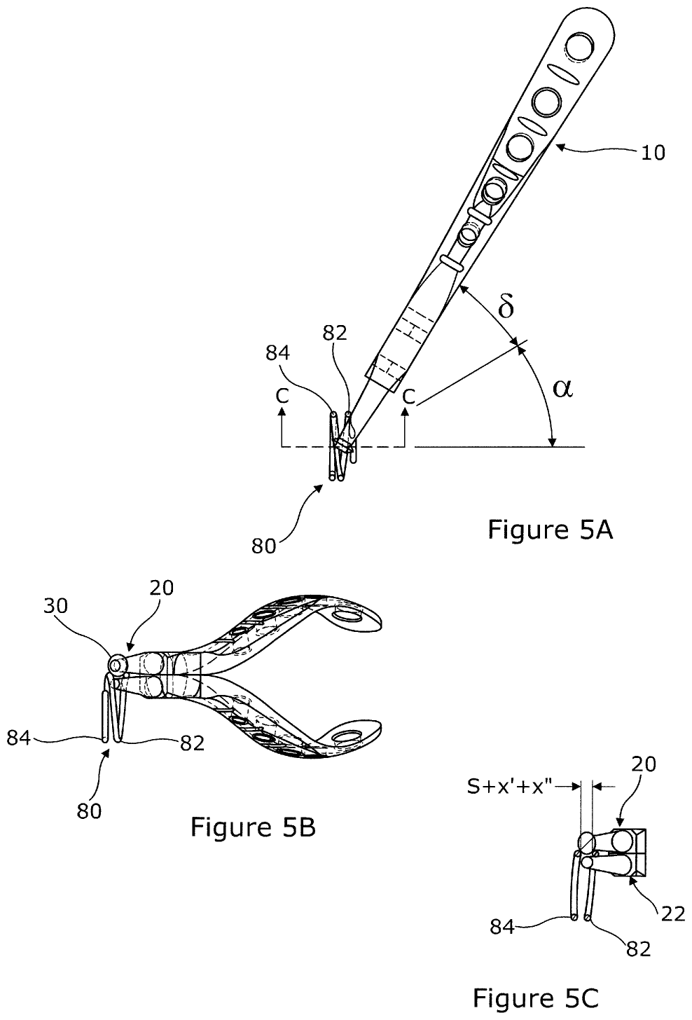

FIGS. 5A, 5B and 5C illustrate schematically a third stage of opening the split ring 80 with the apparatus 10, subsequent to the second stage. As shown by comparing FIGS. 4A and 5A, the apparatus 10 is rotated through a further angle “δ” relative to the split ring 80. This has the effect of further twisting the member 30 between the helical turns 82, 84. In doing so, this causes the helical turns 82, 84 to be separated even further to an amount “S+x¹+x¹¹”

As shown schematically in FIGS. 6A-6F, the member 30 may have a range of different wedge-shaped profiles which provide the arcuate peripheral edge 36. The member 30 of FIG. 6A is the same as that in FIGS. 1-5C (i.e. frustoconical sections arranged back to back), with the arcuate peripheral edge 36 extending 360° around the longitudinal axis of the first jaw 20. In FIG. 6B, the arcuate peripheral edge 36 only extends about 240° around the longitudinal axis of the first jaw 20, leaving a cut-out 90 on the rear side of the first jaw 20 which faces away from the second jaw 22.

FIGS. 6C and 6D correspond to FIGS. 6A and 6B, but instead of having frustoconical sections, the back to back sections of member 30 have a concave radius, giving rise to convex tapering profile in the direction of the longitudinal axis 38 of the first jaw 20.

FIGS. 6E and 6F correspond to FIGS. 6A and 6B, but instead of having frustoconical sections, the back to back sections of member 30 have a convex radius, giving rise to concave tapering profile in the direction of the longitudinal axis 38 of the first jaw 20.

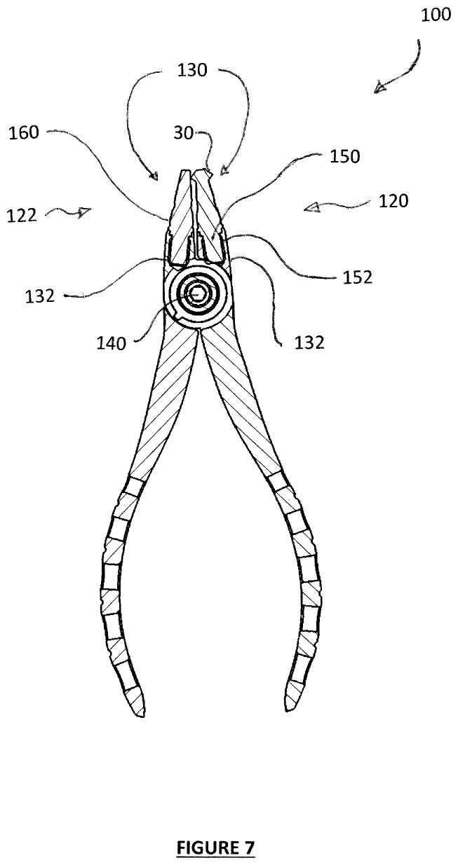

FIG. 7 shows a cross-sectional view of apparatus 100 embodying the present invention. Apparatus 100 has all the features of apparatus 10 and thus works in exactly the same way. Therefore, only the difference between the apparatus 100 and apparatus 10 will be described in detail. The apparatus 100 has a first jaw 120 and a second jaw 122. Each of the jaws 120,122 comprises a distal part 130 which is releasably coupled to a proximal part 132, with the proximal part 132 disposed between distal part 130 and the pivot axis 140 of the apparatus 100. The distal part 130 comprises a shaft 150, and the proximal part 132 comprises a bore 152. The shaft 150 and bore 152 comprise inter-engaging screw threads for releasably coupling the distal part 130 to the proximal part 132. The distal part 130 includes a faceted surface 160 for use when rotating the distal part 130 relative to the proximal part 132 when coupling/decoupling distal and proximal parts 130,132.

The first jaw 120 corresponds to the first jaw 20 of apparatus 10, and thus includes the member 30 having the wedge-shaped profile. The member 30 is mounted on the distal part 130 of the first jaw 120. Due to the fact that the apparatus 100 may need to be used with split rings of different sizes, a plurality of distal parts 130 may be provided, each with a respective member 30 of a different size to the others, for use with split rings of different sizes. In this way, the most appropriately sized distal part 130 for a given split ring may be selected and then releasably coupled to the proximal part 132 before engaging the given split ring with the apparatus 100.

1. Apparatus for opening a split ring, comprising:
a pair of levers pivotally coupled together to define opposed first and second jaws and corresponding handles for opening and closing the first and second jaws; and
a member mounted on the first jaw, the member having a wedge-shaped profile, tapering from a base region adjacent the first jaw to a tip region spaced from the base region, with the tip region being configured for insertion between adjacent helical turns of a split ring when gripped between the first and second jaws,
wherein the tip region has an arcuate peripheral edge which extends from at least one lateral side of the first jaw to the other, and wherein the arcuate peripheral edge of the tip region extends at least partially around a longitudinal axis extending along one lever from the first jaw towards the corresponding handle.

2. Apparatus according to claim 1, wherein the arcuate peripheral edge of the tip region extends at least 180° around the longitudinal axis.

3. Apparatus according to claim 2, wherein the arcuate peripheral edge of the tip region extends 360° around the longitudinal axis.

4. Apparatus according to claim 1, wherein the member has a first surface extending from the tip region to the base region which faces towards a pivot axis of the pair of levers.

5. Apparatus according to claim 4, wherein the first surface is curved around the longitudinal axis.

6. Apparatus according to claim 5, wherein the first surface is at least in part substantially frustoconical.

7. Apparatus according to claim 5, wherein the first surface is concave or convex.

8. Apparatus according to claim 4, wherein the member has a second surface extending from the tip region to the base region which faces away from the pivot axis of the pair of levers.

9. Apparatus according to claim 8, wherein the second surface is curved around the longitudinal axis of the first jaw.

10. Apparatus according to claim 9, wherein the second surface is at least in part substantially frustoconical.

11. Apparatus according to claim 9, wherein the second surface is concave or convex.

12. Apparatus according to claim 1, wherein at least one jaw comprises a distal part releasably coupled to a proximal part, with the distal and proximal parts extending along the longitudinal axis.

13. Apparatus according to claim 12, wherein one part comprises a socket, and the other part comprises a shaft which is received in the socket.

14. Apparatus according to claim 13, wherein the socket and the shaft comprises inter-engaging screw threads for releasably coupling the distal part to the proximal part.

15. Apparatus according to claim 12, wherein the at least one jaw is the first jaw, and the distal part comprises the member having the wedge-shaped profile.
